(19) United States
(12) Patent Application Publication
(10) Pub. No.: US 2009/0132934 A1
(43) Pub. Date: May 21, 2009

(54) Interactive Conferencing System and Method

(75) Inventors: Philippe Le Blancq, Montreal (CA); Francois Goudreault, Louiseville (CA); Sebastien Plourde, Longueuil (CA)

Correspondence Address: POLSINELLI SHUGART PC, 700 W. 47TH STREET, SUITE 1000, KANSAS CITY, MO, 64112-1802, US

(73) Assignee: Net Marketing Soulution.com, Montreal (CA)

(21) Appl. No.: 12/170,216

(22) Filed: Jul. 9, 2008

Related U.S. Application Data
(60) Provisional application No. 60/929,696, filed on Jul. 9, 2007.

(51) Int. Cl. G06F 3/048

(52) U.S. Cl. 715/753

(57) ABSTRACT

An interactive conferencing system and method allowing a plurality of users using interconnected computing devices to interactively share multimedia content. The system comprises a client software located on each computing device of the plurality of users, the client software being so configured as to generate a multimedia container having a display area associated with the multimedia content, the client software allowing the modification of the multimedia content, and a multimedia container server so configured as to store the multimedia container and upon modification of the multimedia content, supplies an updated multimedia content to the client software of the plurality of users so that the modified media content is displayed in the display area associated with the multimedia content.

### CROSS-REFERENCE

This application claims the benefits of U.S. provisional patent applications No. 60/929,696 filed Jul. 9, 2007; which is hereby incorporated by reference.

### TECHNICAL FIELD

The present invention relates to an interactive conferencing system and method.

### BACKGROUND

There exist many communication applications using a variety of multimedia means, for example text messaging, voice, video, etc. However, many of those applications use a peer to peer configuration that does not allow control of inter-user connections, especially within a business context.

Most applications make use of a specific multimedia type, which make it so that in a business context multiple applications may be required. This may lead to problems as each application has specific requirements that may sometimes enter into conflict.

Furthermore, applications often are not compatible with legacy applications such as, for example, existing HTML forms, which in a business context incurs additional costs to adapt or replace legacy applications.

Thus, there is a need for a flexible server based conferencing system and method that allow the use of multiple multimedia types and the integration of legacy application with minimal modifications.

### SUMMARY

The present invention relates to an interactive conferencing system allowing a plurality of users using interconnected computing devices to interactively share multimedia content, the system comprising:
a client software located on each computing device of the plurality of users, the client software being so configured as to generate a multimedia container having a display area associated with the multimedia content, the client software allowing the modification of the multimedia content; and
a multimedia container server so configured as to store the multimedia container and upon modification of the multimedia content, supplies an updated multimedia content to the client software of the plurality of users so that the modified media content is displayed in the display area associated with the multimedia content.

The present invention further relates to a method for interactive conferencing allowing a plurality of users using interconnected computing devices to interactively share multimedia content, the method comprising
generating a multimedia container on each computing device of the plurality of users, the multimedia container having a display area associated with the multimedia content which allows the modification of the multimedia content; and
upon modification of the multimedia content, supplying an updated multimedia content to the multimedia container of the plurality of users so that the modified media content is displayed in the display area associated with the multimedia content.

### BRIEF DESCRIPTION OF THE FIGURES

Embodiments of the invention will be described by way of example only with reference to the accompanying drawings, in which:

FIG. 1 is a schematic view of computing devices connected to an interactive conferencing system through a network;

FIGS. 2a and 2b is a flow diagram depicting the process of a user accessing the interactive conferencing system;

FIG. 3 is a schematic view of an example of an envelope multimedia container structure;

FIG. 4 is a schematic view of the envelope of FIG. 3 with selected applications;

FIG. 5 is a flow diagram depicting the process of users sharing an envelope on the interactive conferencing system;

FIG. 6 is a flow diagram depicting the process of a user making changes to a shared online form; and

FIG. 7 is a flow diagram depicting the process of the initialization of the envelope feature.

### DETAILED DESCRIPTION

Generally stated, the non-limitative illustrative embodiment of the present invention provides a system and method for interactive web conferencing. The system and method provide an envelope feature which is a multimedia container having at least one display area containing, for example, a shared online form, a browser, an ad, an image, a video, a video stream, an audio component, an audio stream, etc. The envelope allows users to interact and share an application such as, for example, an online form.

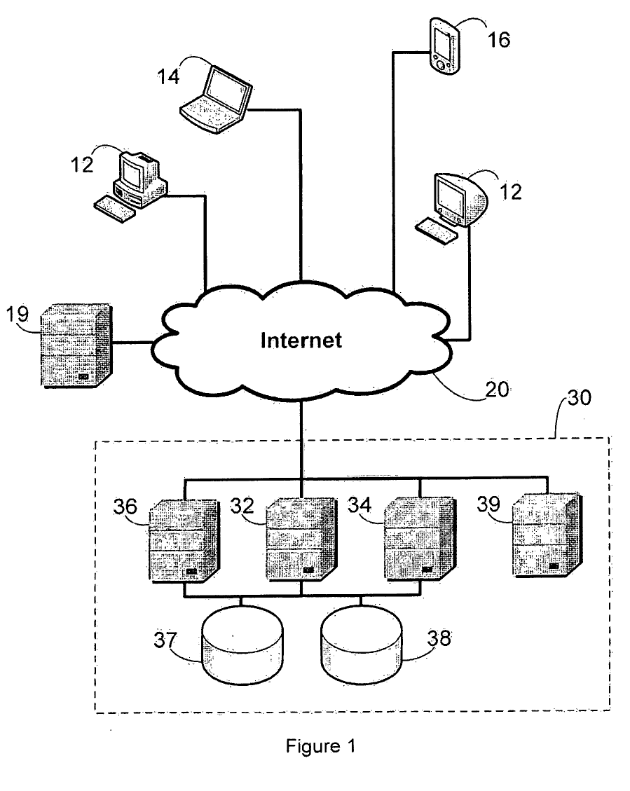

Referring to FIG. 1, a user using a personal computer 12, laptop computer 14 or personal assistant device 16, or any other such computing device, on which runs the client software, may access the interactive conferencing system 30 through connection server 32 via an Internet connection 20 such as, for example, Ethernet (broadband, high-speed), wireless WiFi, cable Internet, satellite connection, cellular or satellite network, etc. Further to the connection server 32, the interactive conferencing system 30 includes an envelope server 34, a multimedia server 36, a transaction database 37 and a user database 38, all of which will be detailed further below. Optionally, the interactive conferencing system 30 may also include a webservice server 39 for access from a web portal provided on a remote webservice server 19.

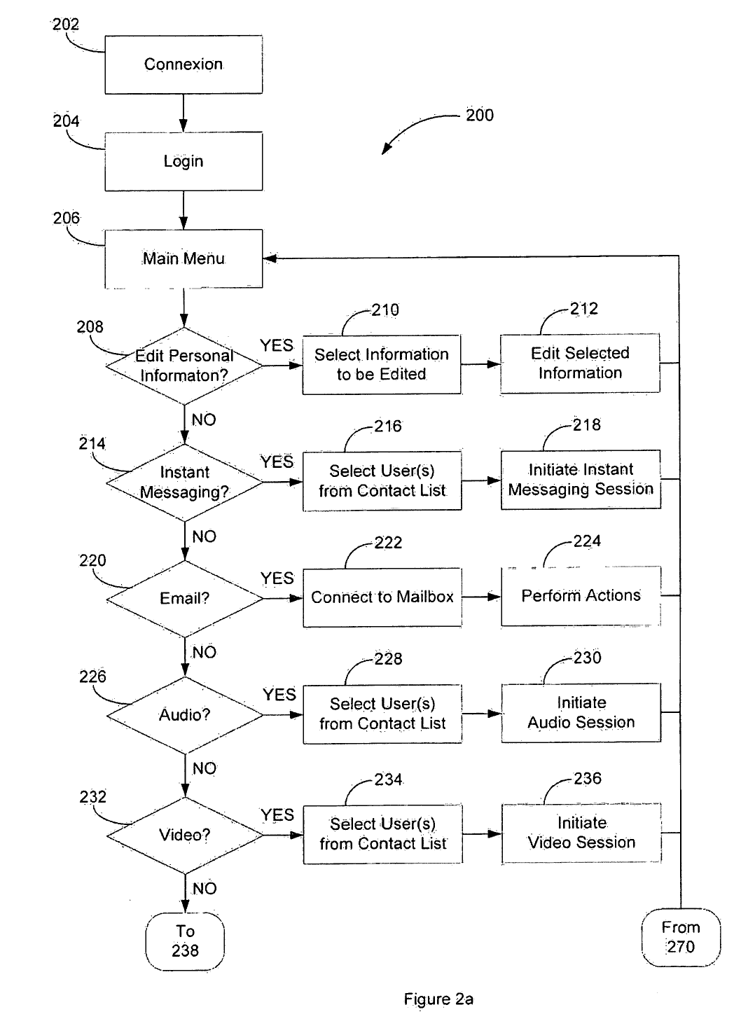

Referring now to FIGS. 2a and 2b, there is shown a flow diagram of an illustrative example of a process 200 executed by a user accessing the interactive conferencing system 30. The steps of the process 200 are indicated by blocks 202 to 270.

The process 200 starts at block 202 where the user connects to the connection server 32 using a personal computer 12, laptop computer 14 or personal assistant device 16 on which runs the client software that uses, for example, the TCP/IP protocol, and, at block 204, logs into the interactive conferencing system 30 using an assigned login and password. The connection server 32 validates the login and password of the user by querying the user database 38 which, if the user is registered, sends back information associated with the user such as, for example, the user profile, domain, permissions, marketing tolerance factor (optional), a relationship table, and initializes the envelope feature. The domain and relationship table as well as the initialization of the envelope feature will be further detailed below.

Then, at block 206, the user accesses the main menu where he may select various options, such as, for example, edit personal information, start and instant messaging session, check or send email, start an audio session, start a video session, send a file, add/invite a user, edit the contact list, create an envelope or send an envelope.

At block 208, the process 200 verifies if the user has selected to edit his/her personal information such as, for example, name, corporation/organization, coordinates, picture, etc. If so, at block 210, the user selects which information field is to be edited and, at block 212, edits the selected information. The process 200 then returns to block 206.

At block 214, the process 200 verifies if the user has selected to initiate an instant messaging session. If so, at block 216, the initiating user selects, from a contact list, which other user(s) he/she wishes to initiate an instant messaging session with and, at block 218, the process 200 connects the initiating user to the multimedia server 36 which initiates the instant messaging session with the selected users. The process 200 then returns to block 206.

At block 220, the process 200 verifies if the user has selected to check or send email. If so, at block 222, the process 200 connects the initiating user to a mailbox on the multimedia server 36 and, at block 224, the initiating user selects actions is to be performed, for example read, delete, forward or respond to emails, manage emails and/or folders, create a new email, etc. The process 200 then returns to block 206.

At block 226, the process 200 verifies if the user has selected to initiate an audio session. If so, at block 228, the initiating user selects, from a contact list, which other user(s) he/she wishes to initiate an audio session with and, at block 230, the process 200 connects the initiating user to the multimedia server 36 which initiates the audio session with the selected users. The process 200 then returns to block 206.

At block 232, the process 200 verifies if the user has selected to initiate a video session. If so, at block 234, the initiating user selects, from a contact list, which other user(s) he/she wishes to initiate a video session with and, at block 236, the process 200 connects the initiating user to the multimedia server 36 which initiates the video session with the selected users. The process 200 then returns to block 206.

At block 238, the process 200 verifies if the user has selected to send a file. If so, at block 240, the sending user selects, from a contact list, which user(s) he/she wishes to send a file to and, at block 242, the process 200 connects the sending user to the multimedia server 36 which initiates a file transfer link with the selected user(s). The process 200 then returns to block 206.

At block 244, the process 200 verifies if the user has selected to add one or more user(s) to the contact list. If so, at block 246, the process 200 verifies, for each added user, if the added user is a registered user of the interactive conferencing system 30 by querying the user database 38. If the added user is not registered, then, at block 248, an invitation to register into the interactive conferencing system 30, along with a link to download the client software, is sent to the added user, after which the process 200 proceeds to block 250. If the added user is registered, the process proceeds to block 250. At block 250, the contact list of the user is updated by adding the added user. In the case the added user is not registered yet, the contact list may list him/her differently so as to indicate this is the case. The process 200 then returns to block 206.

At block 252, the process 200 verifies if the user has selected to edit his/her contact list. If so, at block 254, the user selects actions to be performed such as, for example, order the listed members, create groups of users, modify display options (style, size, color, etc.), and, at block 256, the process 200 updates the contact list according to the actions selected by the user. The process 200 then returns to block 206.

At block 258, the process 200 verifies if the user has selected to create an envelope. If so, at block 260, the initiating activates the envelope editor of the client software, which will be further described below, to create a new envelope and, at block 262, the envelope editor transfers the newly created envelope data to the envelope server 34. The process 200 then returns to block 206.

At block 264, the process 200 verifies if the user has selected to send an envelope. If so, at block 266, the initiating user selects the envelope he/she wishes to send and, from a contact list, which user(s) he/she wishes to send the envelope to. Then, at block 268, the process 200 sends the selected envelope to the selected user(s). The process 200 then returns to block 206.

Finally, at block 270, the process 200 verifies if the user has selected to logout. If so, the process 200 exits, if not, it returns to block 206.

It is to be understood that services such as instant messaging, email, audio link, video link and file transfer implementations are well known in the art. It is also to be understood that some services may be combined, that some services may be omitted or added. For example, a video link may be combined with an audio link or instant messaging.

Furthermore, it is to be understood that the various services may require a specific permission and that depending oh the permissions of the user, some services may not be accessible. Accordingly, users may be separated in various groups, for example host users having all permissions and guest users having variable permissions assigned by a host user. For example, adding new users and creating envelopes, such as described at block 244 and 258, respectively, of process 200, may be restricted to host users.

For the purpose of the following description it will be assumed that a “host user” has all permissions while a “guest user” has a limited subset of permissions. It will also be assumed that reference to a “user” means either a guest or a host user.

### Domain

The users of the interactive conferencing system 30 may be grouped by domain. Usually, a domain belongs to a given company or organization registered with the interactive conferencing system 30. When a new user is added, as per block 244 of process 200, the newly added user will have in his or her contact list all of the users belonging to the same domain.

A public domain may also be used for users not part of a registered corporation or organization. Users part of the public domain may have limited functionality and will only have in their contact list users having added them to their relationship table. Such users may not be allowed, for example, to add users as relations.

Referring back to FIGS. 2a and 2b, the process 200 was described for a given domain to which belongs the user accessing the interactive conferencing system 30. In an alternative embodiment, a user may belong to multiple domains, in which case, at blocks 208, 214, 220, 226, 232, 238, 244, 252, 258 and 264, the user may be given the option to select for which domain the selected option is to be performed. In a further alternative embodiment, a user, provided he or she is given the proper permission, may be allowed to create new domains.

### Relationship Table

Each user has an associated relationship table that establishes that user's relation with each user part of its contact list. Each listed user may or may not belong to the same domain as the user. All functionalities of the interactive conferencing system 30 may be used with a user with which a relationship is established.

It is to be understood that the relationship table may be empty or that the interactive conferencing system 30 may prevent a user from interacting with some or all users belonging to different domains.

The relationship table may also contain information such as the type of user, i.e. guest or host, as well as a list of permissions associated with the user. Alternatively, the relationship table may simply contain user ID's with which the user related data may be queried from the user database 38.

In an alternative embodiment, the relationship table of host users may be automatically updated by the interactive conferencing system 30 to include all users belonging to a common domain, thus allowing the host user to interact though his or her contact list with those users. For example, if a guest user invites a new user, this new user will be added to the contact list and relationship table of the guest user as well as the contact list and relationship table of any host user of the domain to which the guest user belongs.

### Envelope

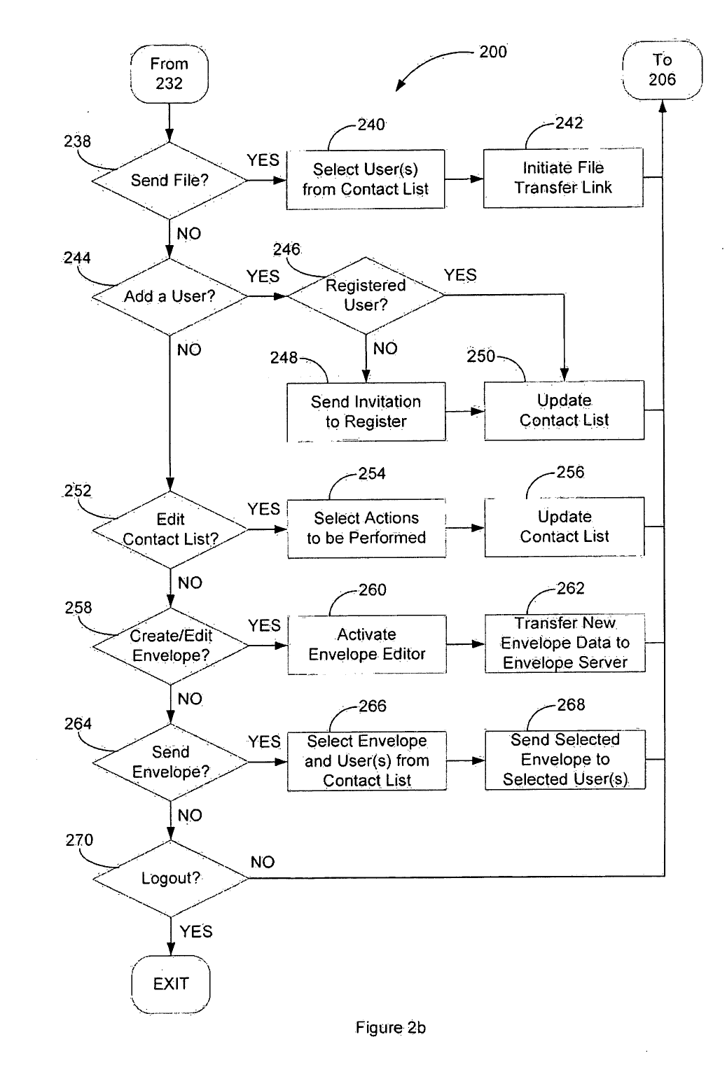

As previously mentioned, the envelope is a multimedia container having at least one display area containing, for example, a shared online form, a browser, an ad, an image, a video, a video stream, an audio component, an audio stream, etc. Referring to FIG. 3, there is shown an example of an envelope 300 having three display areas 302, 304 and 306 for containing multimedia applications such as listed above. It is to be understood that the envelope is not limited to the number of displays areas shown in envelope 300 and that envelope 300 is used for illustrative purposes only.

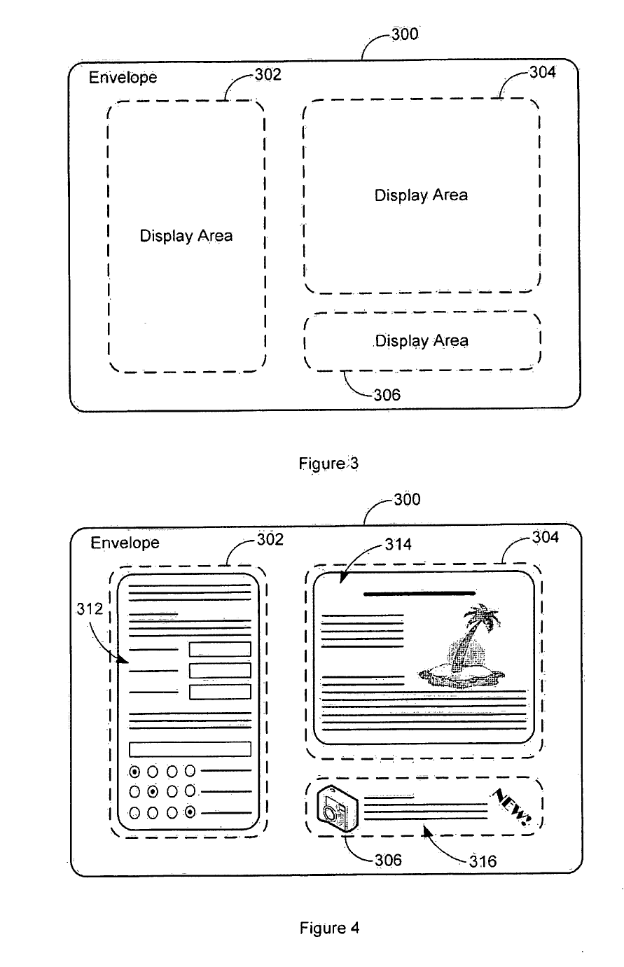

Referring now to FIG. 4, the display areas 302, 304 and 306 of FIG. 3 may contain, for example, a shared online form 312, a web browser 314 and an ad 316, respectively. The envelope 300 may be used, for example, in the context of an online travel agency. In this context, the shared online form 312 may be used by both a client and a travel agent in order to complete the contract, i.e. enter destination, departure and return dates, flight numbers, provide credit card information, etc., the web browser 314 may be used to view information and pictures of a selected destination or resort and the ad 316 may simply provide context targeted advertisement.

It is to be understood that the envelope 300 may also provide functionalities such as, for example, text, audio or audio/video conversation between the client and the travel agent that may be provided within or outside the envelope. These functionalities will be detailed further below.

### Shared Online Form

A form may be, for example, a HTML page located on the multimedia server 36 viewed through a browser shell within an envelope managed by the envelope server 34. The HTML page contains javascript commands, with associated library, that are interpreted by the envelope server 34 and informs it that the form is a shared online form and that its content is to be synchronize between the various users sharing the form.

In order to allow this synchronization, each user should have options such as “active scripting” and “allow paste operations via script” active in their respective browser's internet configuration. Optionally, an introduction page may inform users of the required options for the proper functioning of the shared online form.

The javascript commands are also used to link event driven commands from the HTML page with database commands, i.e. transaction database 37, for example a Delphi™ database.

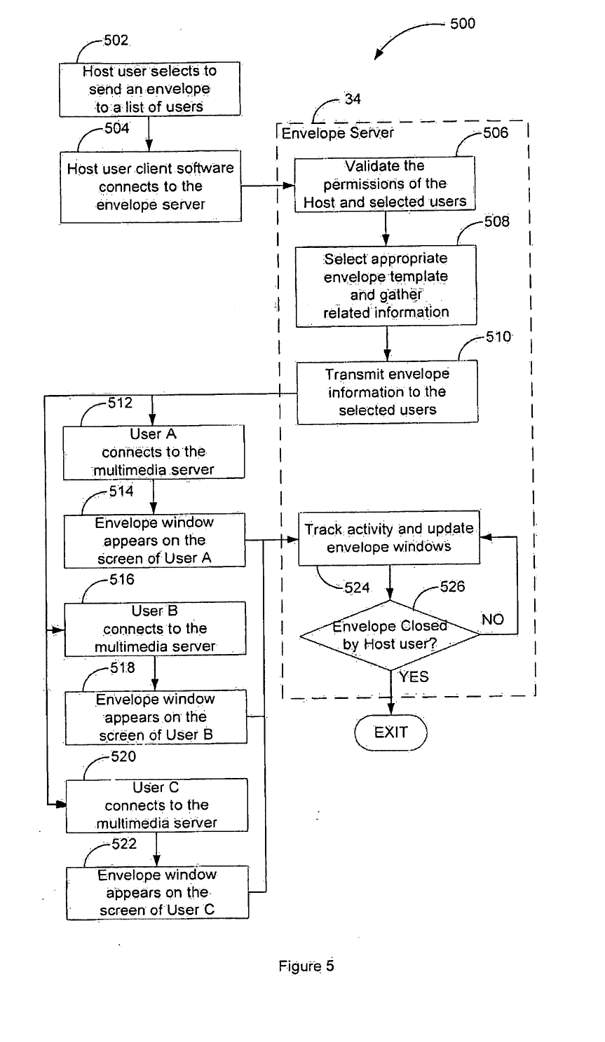

Referring to FIG. 5, there is shown a flow diagram of an illustrative example of the process 500 of a host and guest users sharing an envelope on the interactive conferencing system 30. The steps of the process 500 are indicated by blocks 502 to 526.

The process 500 starts at block 502 where the host user selects a list of users, within a given domain, with which he or she wishes to share an envelope and, at block 504, the host user's client software connects to the envelope server 34 providing it with the list of selected users along with the identification of the envelope to be shared.

At block 506, the envelope server 34 validates the permissions of the host and selected users by, for example, querying the user database 38.

Then, at block 508, the envelope server 34 selects the appropriate envelope template, gathers the information related to the envelope, i.e. URL(s), links to audio/video files, etc. and, at block 510, transfers the envelope information to the selected users, for example users A, B and C.

At blocks 512, 516 and 520, the selected users A, B and C, respectively, connect to the multimedia server 34 and, at blocks 514, 518 and 522, the envelope window appears on the respective screens of selected users A, B and C. It is to be noted that the envelope window also appears on the screen of the host user.

Then, at block 524, the envelope server 34 keeps track of the envelope activity of each user, i.e. users A, B, C and host user, and, in the case where the envelope contains a shared online form, updates the envelope window of each user whenever any one of the users makes any changes on the shared online form.

Finally, at block 526, the envelop server 34 verifies if the envelope has been closed by the host user. If so the process 500 exits, if not, it proceeds back to block 524.

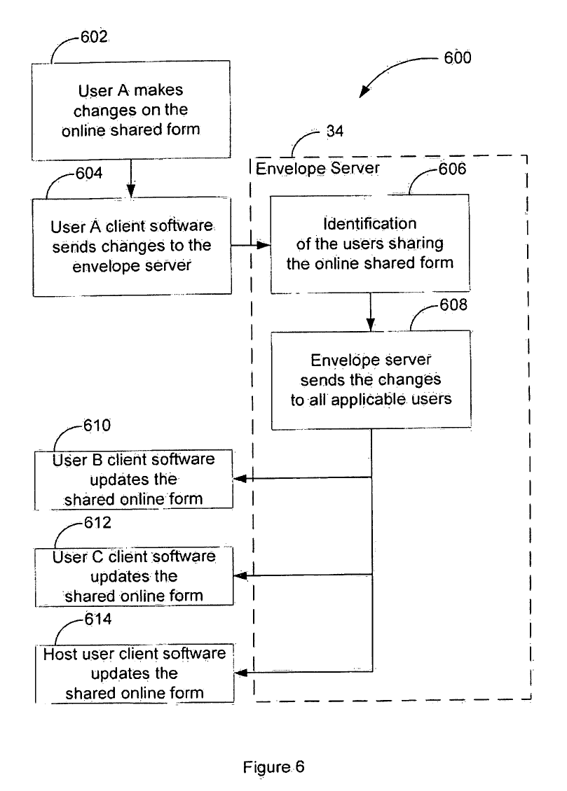

Referring now to FIG. 6, there is shown a flow diagram of an illustrative example of the process 600 that may be executed at block 524 of process 500 (see FIG. 5) when a user, for example user A, makes changes to a shared online form. The steps of the process 600 are indicated by blocks 602 to 614.

The process 600 starts at block 602 where user A makes a change to a shared online form, after which, at block 604, the client software of user A sends the changes to the envelope server 34.

Then, at block 606, the envelope server 34 identifies the users sharing the shared online form and, at block 608, sends the changes to the identified, for example users B, C and the host user.

Finally, at blocks 610, 612 and 614, the client software of users B, C and the host user update their respective shared online form so that they reflect the changes effectuated by user A.

In an alternative embodiment, a hidden field may be incorporated into each HTML page interacting with the transaction database 37 so as to ensure that an operation is executed only once. For example, in the context of online shopping, the user buying a certain item or service confirms the transaction and the envelope server 34 updates the HTML page of all the users sharing the online form, for example setting a flag indicating that the transaction was completed, so that the transaction is only executed once.

The following commands are an example of a protocol that may be used for communications between the client software of the various users and the envelope server 34.

The commands include:

CMD_ENVELOPE informs the client software that the data relate to an envelope;

CMD_CONTENT informs the client software that the data relate to an application contained in the envelope;

CMD_ENVELOPE_SIZE informs the client software of the possible envelope sizes;

CMD_ENVELOPE_ID informs the client software that the data relate to the ID of the envelope;

CMD_CONTENT_ID informs the client software that the data relate to the ID of an application of the envelope;

CMD_DELETE_ENVELOPE informs the client software to delete all data related to the envelope;

CMD_DELETE_CONTENT informs the envelope server 34 to delete the data related to an application;

CMD_TRANSFER_COMPLETE informs the envelope server 34 that all data has been transferred;

CMD_GET_TFC_FILE informs the envelope server 34 that we wish to obtain the verification file which contains the name and size of the individual files used by the envelope;

GMD_SEND_ENVELOPE informs the envelope server 34 that it is to send the envelope to selected users;

CMD_SHOW_ENVELOPE informs the client software to show the envelope;

CMD_UPDATE_INPUT informs the client software that the content of a text input of the shared online form was modified;

CMD_DELETE_INPUT informs the client software that the content of a text input of the shared online form was deleted;

CMD_RADIO informs the client software that the value of a radio element of the shared online form was modified;

CMD_BUTTON informs the client software that a button of the shared online form was clicked;

CMD_SELECT informs the client software that the content of a select element of the shared online form was selected;

CMD_CHECKBOX informs the client software that a checkbox of the shared online form was checked;

CMD_GO_TO informs the client software to access a web page at the provided URL;

CMD_SUBMIT informs the client software that a submit element of the shared online form was clicked;

CMD_ENVELOPE_MANAGER informs the client software that the user has the permission to create an envelope;

CMD_MY_ENVELOPE informs the client software that the user is the owner of the envelope;

CMD_ENVELOPE_TO_BROADCAST informs the client software that the envelope is available for sending;

CMD_RECEIVED_ENVELOPE informs the client software that the user has previously received the envelope;

CMD_GET_ENVELOPE_INFO informs the envelope server 34 to transmit all the data concerning the envelope; and

CMD_SCHEDULED_BROADCAST informs the envelope server 34 of data relative to the programmed sending of the envelope, for example an add or coupon which is to be displayed the first time a new user logs into the interactive conferencing system 30.

Referring back to the process 600 of FIG. 6, the sending of the changes to the shared online form from the client software of user A to the envelope server 34 at block 604 may be performed using, for example, commands such as CMD_UPDATE_INPUT, CMD_DELETE_INPUT, CMD_RADIO, CMD_BUTTON, CMD_SELECT, CMD_CHECKBOX, CMD_GO_TO or CMD_SUBMIT, along with the envelope ID, name of the form, etc., ending with, for example, a CMD_TRANSFER_COMPLETE command to indicate that all the pertinent data has been sent. Then, at block 606, the envelope server 34 may identify the users sharing the shared online form using the envelope ID.

### Further Envelope Functionalities

Further to the commands described above with regard to the protocol that may be used for communications between the client software of the various users and the envelope server 34, the following commands may also be incorporated into a form or other HTML page located on the multimedia server 36 viewed through an envelope managed by the envelope server 34.

CMD_START_CONVERSATION informs the envelope server 34 to start a text, audio or audio/video conversation between selected users.

CMD_SEND_FILE informs the envelope server 34 to send one or more provided file(s) to selected users.

CMD_SEND_MESSAGE informs the envelope server 34 to send a provided message to selected users.

CMD_GET_USER_STATUS informs the envelope server 34 to provide a status (i.e. online, away, offline, etc.) of the domain users or of selected users.

It is to be understood that other commands may be added, each command being in the form of a javascript command having an associated library that is interpreted by the envelope server 34.

### Envelope Editor

An envelope editor may be used to specify the layout and parameters of the envelope. The layout specification may include, for example, the dimensions of the envelope and the number, position, size of the display areas. As for the parameters, these may include, for example, user permissions, the type of applications to be included in each display area, links to forms, images or video, etc.

When the envelope editor is activated, the client software connects to the envelope server 34 and requests a list of required envelope files, verifies if it is missing any file or if a file has been updated. If so, it requests the missing or updated files from the envelope server 34 which transfers the requested files.

The envelope editor may be, for example, in the form of a rapid application development (RAD) process within the client software which lets an authorized user add elements such as display windows and associated applications to a canvas and specify certain attributes depending on the type of application. When the creation of the new envelope has been completed, the client software transfers the new envelope data to the envelope server 34.

For example, referring back to FIG. 4, the envelope editor may be used to set the dimensions of the envelope 300, the number, position and size of each display area 302, 304 and 306, as well as their content 312, 314 and 316, respectively.

Regarding user permissions, specific users may be identified as envelope managers which have the permission to create, modify, assign and distribute envelopes.

Other users may be given the permission, on a case by case basis if desired, to use a subset of the above mentioned functionalities.

Finally, there are users which do not have any permission but are allowed to receive envelopes. For example, a user having no permission may received an envelope including a shared online form and use that form.

In an alternative embodiment, the envelope server 34 may save, for example on the transaction database 37, a history of received envelopes for each user. The user is thus allowed to consult previously received envelopes. In the case of shared online forms, this may take the form, for example, of the completed form without allowing the user to make any changes to the form.

### Initialization of the Envelope Feature

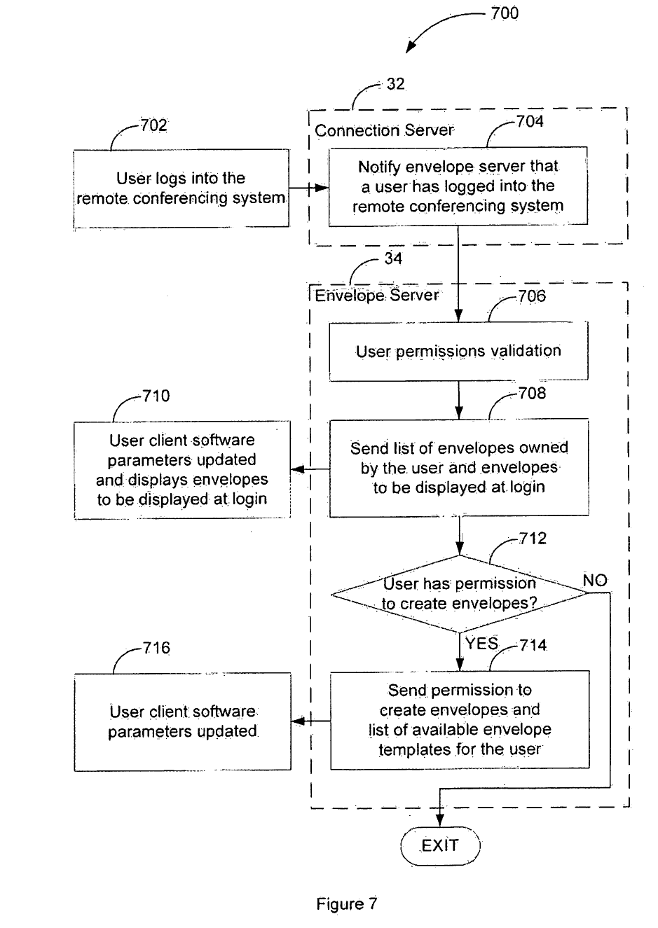

Referring to FIG. 7, there is shown a flow diagram of an illustrative example of the process 700 of the initialization of the envelope feature. The steps of the process 700 are indicated by blocks 702 to 716.

The process 700 starts at block 702 where the user logs into the interactive conferencing system 30, at which time, at block 704, the connection server 32 notifies the envelope server 34 that a user has logged into the interactive conferencing system 30.

Then, at block 706, the envelope server 34 validates the permissions of the user by, for example, querying the user database 38.

At block 708, the envelope server 34 sends a list of envelopes owned by the user and envelopes to be displayed at login using, for example, the CMD_MY_ENVELOPE, CMD_ENVELOPE and CMD_SHOW_ENVELOPPE commands from the envelope protocol, following which, at block 710, the user's client software parameters are updated and the appropriate envelopes are displayed. Envelopes to be displayed at login may include, for example, messages from the interactive conferencing system 30, messages from other users, public interest messages, advertisement, promotion, etc. The process 700 then proceeds to block 712.

At block 712, the envelope server 34 verifies if the user has the permission to create envelopes by querying the user database 38. If not, the process 700 exits. If the user does have the permission to create envelopes, then, at block 714, the envelope server 34 sends the permission to the user's client software using, for example, the CMD_ENVELOPE_MANAGER command, along with a list of available envelope templates, after which, at block 716, the user's client software parameters are updated.

### Webservice Functionalities

As previously mentioned, with reference to FIG. 1, the interactive conferencing system 30 may optionally include a webservice server 39 for access from a web portal provided on a remote webservice server 19. A user from a remote site may connect to a HTML page located on the remote webservice server 19 in order to remotely manage and/or use some of the functionalities of the interactive conferencing system 30. To this end, the remote webservice server 19 communicates with the webservice server 39 using commands based on the web services architecture. The webservice server 39 then provides the request to the envelope server 34 and also returns information to the remote webservice server 19 to be displayed on the web portal.

One example of use of the webservice functionalities is the remote broadcast of envelopes to selected users. An authorized user, such as, for example, a host user, may remotely send envelopes to users part of one of his or her domain (or to a subset of such users) using a web portal on a remote webservice server 19. It is to be understood that the contact list and relationship table will dictate if and to which users the host user may remotely send envelopes to.

Some of the commands available remotely through the web service architecture are:

REFRESH_RELATIONS informs the envelope server 34 to refresh the user's relationship table;

OPEN_ENVELOPE informs the envelope server 34 to open an envelope for selected users;

KICK_ALL_USERS informs the envelope server 34 to disconnect all users;

KICK_USER informs the envelope server 34 to disconnect selected users;

STOP_SERVICE informs the envelope server 34 to stop its service;

START_SERVICE informs the envelope server 34 to start its service;

SEND_GOTO informs the envelope server 34 to modify the content of a previously opened envelope (for example to change a displayed URL);

DISPLAY_MSG informs the envelope server 34 to display a provided message to selected users or to a public chat room;

SEND_ENVELOPE informs the envelope server 34 to initiate a scheduled broadcast; and

LIST_USERS requests from the envelope server 34 a list of connected users, optionally all registered users may be listed indicating a status for each user.

It is to be understood that other commands may be added and that the availability of a given command, as well as the domains or users to which the commands may be applied, will be dictated by the relationship table of the initiating user.

### Marketing Tolerance Factor

As previously mentioned, the user database 38 may contain an optional marketing tolerance factor associated with each user. The marketing tolerance factor may be used at block 710 of the process 700 of FIG. 7 to determined if an envelope is to be displayed or not at login based on the degree to which the user belongs to the target audience of the envelope content. The tolerance factor may be subdivided in various envelope content categories in order to provide, for example, user targeted advertisement.

In an alternative embodiment, the tolerance factor may be modulated according to whether or not the user clicks on the content of a specific envelope, for example an advertisement or promotion. The increase or decrease in the tolerance factor for a given envelope content category may vary depending on the degree to which the user was determined to be part of the target audience in order to adapt to changing user interests.

It is to be understood that although reference is made to separate servers 32, 34, 36 and 39 as well as separate databases 37 and 38, these may be implemented on one or more physical device and/or may be combined.

Although the present invention has been described by way of particular embodiments and examples thereof, it should be noted that it will be apparent to persons skilled in the art that modifications may be applied to the present particular embodiment without departing from the scope of the present invention.

What is claimed is:

1. An interactive conferencing system allowing a plurality of users using interconnected computing devices to interactively share multimedia content, the system comprising:
a client software located on each computing device of the plurality of users, the client software being so configured as to generate a multimedia container having a display area associated with the multimedia content, the client software allowing the modification of the multimedia content; and
a multimedia container server so configured as to store the multimedia container and upon modification of the multimedia content, supplies an updated multimedia content to the client software of the plurality of users so that the modified media content is displayed in the display area associated with the multimedia content.

2. A method for interactive conferencing allowing a plurality of users using interconnected computing devices to interactively share multimedia content, the method comprising
generating a multimedia container on each computing device of the plurality of users, the multimedia container having a display area associated with the multimedia content which allows the modification of the multimedia content; and
upon modification of the multimedia content, supplying an updated multimedia content to the multimedia container of the plurality of users so that the modified media content is displayed in the display area associated with the multimedia content.
